(19) United States
(12) Patent Application Publication
(10) Pub. No.: US 2026/0129075 A1
(43) Pub. Date: May 7, 2026

(54) ARTIFICIAL INTELLIGENCE-DRIVEN CYBERSECURITY SYSTEM AND CYBERSECURITY METHOD WITH DYNAMIC REVERSE AUTHENTICATION

(71) Applicants: CHAO-HUNG LIN, New Taipei City (TW); Farxun Wisdom INC., New Taipei City (TW)

(72) Inventor: CHAO-HUNG LIN, New Taipei City (TW)

(21) Appl. No.: 19/369,707

(22) Filed: Oct. 27, 2025

(30) Foreign Application Priority Data
Oct. 30, 2024 (TW) 113141489

(51) Int. Cl. H04L 9/40

(52) U.S. Cl. CPC H04L 63/1458; H04L 63/0236; H04L 63/1416; H04L 63/1425

(57) ABSTRACT

An AI-driven network security system that proactively detects and mitigates threats in enterprise environments is provided. The system integrates AI-based behavioral analysis to model normal activity and identify anomalies. It implements a Reverse Authentication Algorithm (RAA) to generate a unique 32-hex-character (128-bit) authentication (“au”) string formed from random hexadecimal values, a complement-masked timestamp, and a search string dynamically derived from an ASCII random string table. Incoming requests are validated by reconstructing and verifying the timestamp and by recomputing the search string extracted from the au string. Upon anomaly detection or authentication failure, the system triggers layered defenses including packet filtering, IP blocking via a blocklist, execution of custom threat-neutralization scripts, and integration with content delivery networks (CDNs) to mitigate volumetric attacks. The modular architecture enables real-time detection and response while integrating with existing infrastructure.

### FIELD OF THE INVENTION

The present disclosure relates generally to network security systems and, more specifically, to an AI-driven cybersecurity solution configured to proactively detect and respond to diverse network threats by leveraging advanced machine-learning techniques and novel authentication mechanisms to improve an enterprise network's security posture.

### BACKGROUND OF THE INVENTION

Organizations increasingly depend on complex network infrastructures to support operations, store sensitive data, and facilitate communications, while the frequency and sophistication of threats continue to rise, jeopardizing the integrity, confidentiality, and availability of critical information systems. Traditional rule-based measures-such as firewalls and intrusion detection systems-rely on predefined signatures and static rules and thus face limitations in coping with emerging and targeted attacks that fall outside known signatures. Insider threats are likewise difficult to detect due to legitimate privileges that obscure the boundary between normal and malicious behavior.

Distributed Denial-of-Service (DDOS) attacks overwhelm network resources, and rate-limiting or static traffic filtering may be insufficient against large-scale or volumetric variants. Connection-oriented attacks (e.g., Slow HTTP and CC) further complicate the landscape by exploiting protocol or application-layer weaknesses, demanding continuous monitoring and dynamic response strategies.

To address these challenges, there is a growing need for solutions that combine advanced analytics and adaptive learning. AI and machine learning enhance threat detection and response by analyzing large-scale data, identifying anomalous patterns, and adapting in real time. Robust authentication is also vital: static passwords or token-based schemes remain vulnerable to credential theft and replay, motivating authentication algorithms that generate dynamic, unique identifiers. Integrating these technologies into a comprehensive framework requires tight coupling of data collection, behavioral analysis, detection, and response, while maintaining scalability, compatibility, and minimal disruption to legitimate activity.

### SUMMARY OF THE INVENTION

This disclosure provides an advanced network security system that combines AI-driven behavioral analysis with a novel Reverse Authentication Algorithm (RAA) to proactively detect and respond to security threats. The system improves security posture beyond rule-based measures by integrating dynamic authentication with continuous anomaly detection.

A behavior-analysis module collects comprehensive network data—including traffic logs, geolocation, network parameters, timestamps, and device information—and applies machine-learning models to model normal behavior and identify anomalies in real time, enabling adaptation to evolving threats.

In one embodiment, the RAA generates a unique 32-hex-character (128-bit) au string composed of a complement-masked timestamp, random hexadecimal values, and a search string derived from an ASCII random string table. By resisting prediction and replay, the au string serves as a time-sensitive authentication marker that complements existing credentials.

Upon anomaly detection or authentication failure, the system initiates layered defense responses, including packet filtering to remove malicious data, automatic IP blocking via a blocklist, execution of custom scripts (e.g., Python, Bash, or C/C++), and CDN integration to distribute traffic and mitigate DDOS attacks, thereby maintaining availability during large-scale events.

The system also monitors user-behavior patterns to detect potential insider threats. Overall, by combining AI-based analysis, dynamic authentication, and layered defenses, the architecture offers a modular, scalable, and infrastructure-compatible solution for protecting enterprise networks against known and emerging threats.

### BRIEF DESCRIPTION OF THE DRAWINGS

The accompanying drawings are provided to illustrate exemplary embodiments of the present invention and are not intended to limit the scope thereof. Identical reference numerals denote identical elements throughout the drawings.

FIG. 1 is a block diagram illustrating an architecture of a network security system according to an embodiment.

FIG. 2 is a block diagram illustrating a data collection module of the network security system.

FIG. 3 is a block diagram illustrating an AI analysis engine of the network security system.

FIG. 4 illustrates an example authentication (“au”) string generated by the Reverse Authentication Algorithm (RAA).

FIG. 5A and FIG. 5B are flowcharts illustrating an example process for generating the authentication string by a Reverse Authentication Algorithm (RAA).

FIG. 6A and FIG. 6B are flowcharts illustrating an example process for verifying the authentication string by the Reverse Authentication Algorithm (RAA).

FIG. 7 is a block diagram illustrating a defense response module of the network security system.

FIG. 8 is a flowchart illustrating an example operational flow of the network security system.

### DESCRIPTION OF THE PREFERRED EMBODIMENTS

The present invention relates to a network security system that integrates artificial intelligence and a novel Reverse Authentication Algorithm (RAA) to proactively detect, analyze, and respond to various network threats in an enterprise network environment. This detailed description sets forth the components and operational procedures of the network security system so that persons skilled in the art can understand and implement the invention.

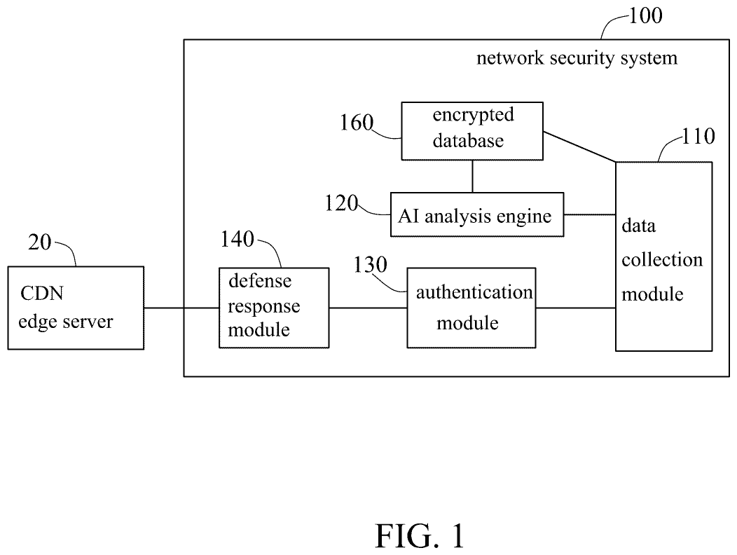

Referring to FIG. 1, FIG. 1 illustrates an architectural diagram of an embodiment of the network security system of the present invention. The network security system 100 is architected as a modular and scalable platform that includes multiple interconnected components: a data collection module 110, an AI analysis engine 120, an authentication module 130 equipped with a Reverse Authentication Algorithm 132, and a defense response module 140. Each component is designed to operate independently as well as cooperatively, ensuring comprehensive protection against network threats while maintaining high performance and adaptability.

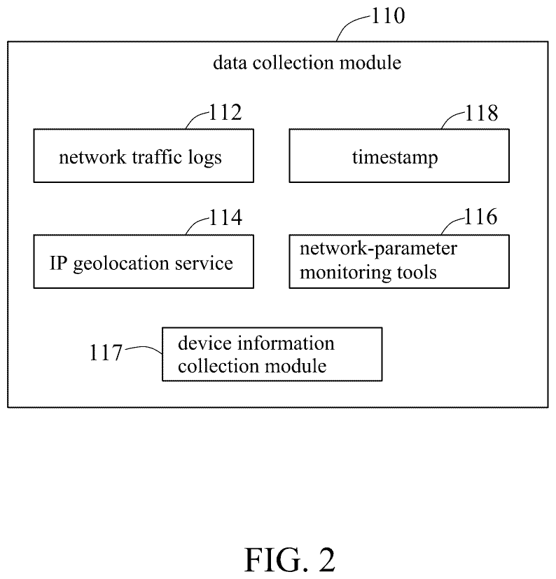

Referring also to FIG. 2, FIG. 2 illustrates an architectural diagram of an embodiment of the data collection module of the present invention. The data collection module 110 is responsible for collecting the broad network data required for analysis and threat detection. The data collection module 110 is kept in continuous operation to ensure the availability of real-time data. The data collection module 110 gathers various types of data and includes a network-traffic log 112 to capture details of inbound and outbound traffic, such as source and destination IP addresses, port numbers, protocols, and packet sizes. In addition, geolocation information is collected through a geolocation service 114 to determine the in geographic locations of connected entities. Furthermore, a network-parameter monitoring tool 116 is used to monitor various network parameters, such as latency, throughput, and error rate. Moreover, the data collection module 110 records precise timing information for each network event by means of a timestamping component 118, and uses a device-information collection module 117 to collect device information, including MAC addresses, operating systems, and device configurations.

The data collection module 110 is implemented through a combination of passive monitoring, active probing, and API integration. Passive monitoring uses techniques such as network test access points and port mirroring to observe traffic without interfering with network operations, whereas active probing sends test packets to measure network performance and detect anomalies. The data collection module 110 also interfaces via APIs with existing network devices and security systems to aggregate logs and alerts. The collected data is managed using real-time data processing based on stream processing frameworks to handle high-velocity data, and is securely stored in an encrypted database 160 with strict access controls to ensure integrity and confidentiality. Data-retention policies are implemented in accordance with organizational policies and regulatory requirements, ensuring that data is retained for a configurable period as needed.

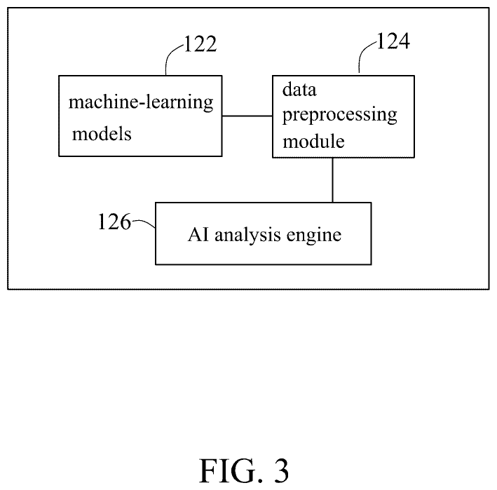

Referring also to FIGS. 1 and 3, FIG. 3 illustrates an architectural diagram of an embodiment of the AI analysis engine of the present invention. The AI analysis engine 120 identifies potential threats by applying machine-learning algorithms to the data collected by the data collection module 110. The AI analysis engine 120 employs various machine-learning models 122, including behavioral modeling that establishes normal network and user behavior based on historical data, and unsupervised learning algorithms such as cluster analysis and autoencoders to identify anomalies that deviate from established behavioral patterns. Predictive analytics are also applied by means of supervised learning models trained on labeled datasets to forecast potential threats based on observed indicators.

In this embodiment, a data preprocessing module 124 within the AI analysis engine 120 includes normalizing raw data into formats suitable for analysis, extracting relevant features such as access frequency, access time, and data transfer volume, and applying dimensionality-reduction techniques such as Principal Component Analysis (PCA) to reduce data complexity without losing important information. Real-time analysis is facilitated by stream-processing technologies such as Apache Kafka and Apache Flink, enabling the network security system 100 to analyze data as it is being collected. A feedback loop is established to continuously update the machine-learning models based on new data and feedback from the defense response module, ensuring that the machine-learning models 122 remain up-to-date and effective.

The AI analysis engine 120 classifies threats into various categories, including external threats originating outside the network-such as distributed denial-of-service (DDoS) attacks, malware infiltration, and phishing attacks; internal threats that involve malicious or inadvertent behavior by authorized users, identified via behavioral deviations; and zero-day attacks that reveal previously unknown vulnerabilities, recognized by detecting anomalous patterns that do not match known signatures. In addition, the AI analysis engine 120 further includes an AI auditor component 126 that conducts an in-depth analysis of user behavior patterns to detect internal threats. It monitors user activities to identify abnormal access patterns, such as access outside normal working hours or attempts to access atypical resources, and alerts administrators to potential privilege escalation or unauthorized access attempts.

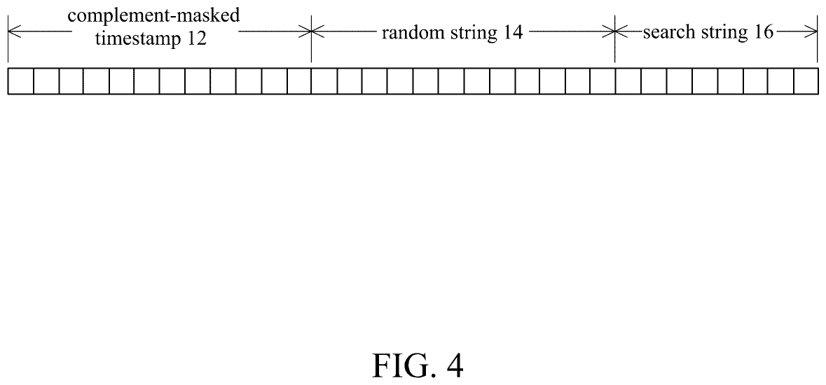

Referring also to FIGS. 1 and 4, FIG. 4 illustrates an embodiment of an authentication string generated by the authentication algorithm of the present invention. The authentication module 130 implements a Reverse Authentication Algorithm (RAA) 132 to enhance security through a dynamic and robust authentication mechanism. In this embodiment, the RAA generates a unique 32-hex-character (128-bit) authentication string (in FIG. 4 and hereinafter abbreviated as “au string 10”), which is designed to be time-sensitive and resistant to prediction and replay attacks. The au string 10 is composed of an obfuscated timestamp 12 (a total of 12 hex characters), a random string 14 composed of random hexadecimal numbers (a total of 12 hex characters), and a search string 16 derived from an ASCII random-string table (a total of 8 hex characters).

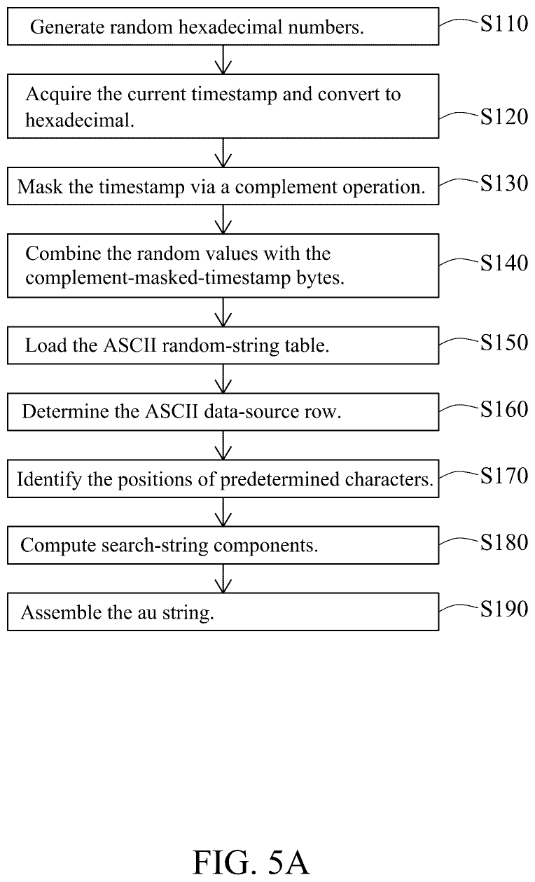

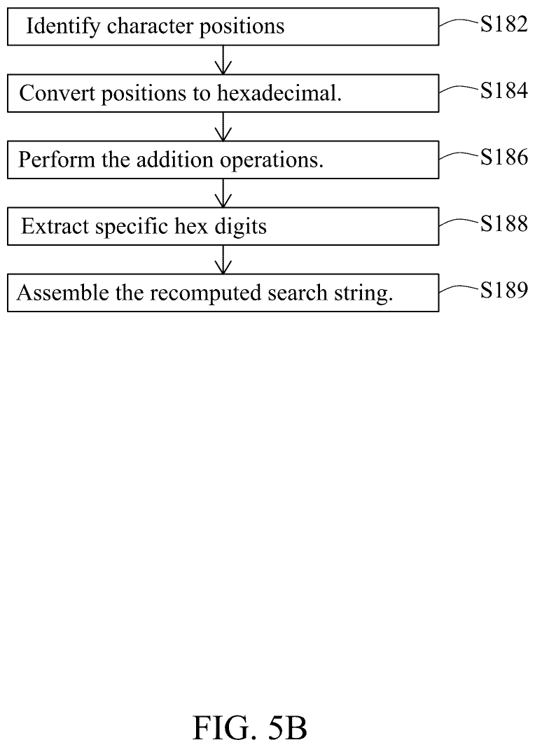

The generation process of the au string 10 involves multiple sophisticated steps to ensure its uniqueness and security. The detailed process for generating the authentication string in one embodiment is outlined below. Referring to FIG. 5A, FIG. 5A shows a flowchart of an embodiment of the authentication algorithm for generating the authentication string.

### Step S110: Generating Random Hexadecimal Numbers

As shown in step S110, the generation process begins by generating four random hexadecimal numbers within a specified range to form the random string 14. The specified range for each random hexadecimal number (denoted here as r1_hex, r2_hex, r3_hex, and r4_hex) is from 0x100 to 0xF00 (i.e., decimal 256 to 3840), thereby ensuring sufficient randomness and complexity.

### EXAMPLE

$$r1\_hex = random\_range ( 0 \times 100 , 0 \times F 00 ) = ‘ e 04 ’$$

$$r2\_hex = random\_range ( 0 \times 100 , 0 \times F 00 ) = ‘ a 62 ’$$

$$r3\_hex = random\_range ( 0 \times 100 , 0 \times F 00 ) = ‘ 1 c 3 ’$$

$$r4\_hex = random\_range ( 0 \times 100 , 0 \times F 00 ) = ‘ d 09 ’$$

These random hexadecimal numbers provide the necessary baseline randomness for the obfuscated timestamp and for generating the search string.

### Step S120: Obtaining and Converting the Current Timestamp

In step S120, the current timestamp in decimal form is obtained (denoted here as ts_dec). For example, consider GMT time: Saturday, Jun. 4, 2022, 02:14:30 a.m.:

$$ts\_dec = 1654308870$$

Then the decimal timestamp is converted into its hexadecimal representation (denoted here as ts_hex):

$$ts\_hex = dec\_to \_hex ( ts\_dec ) = ‘ 629 ac 006 ’$$

### Step S130: Obfuscating the Timestamp Using a Complement Operation

As shown in step S130, a complement operation is applied to obfuscate the timestamp, which enhances security by obscuring the actual timestamp value. The complement operation uses the maximum 32-bit unsigned integer value (0xFFFFFFFF):

$$ts\_hex \_com = 0 xFFFFFFFF - ts\_hex = 0 xFFFFFFFF - ‘ 629 ac 006 ’ = ‘ 9 d 653 ff 9 ’$$

The complemented timestamp (denoted here as ts_hex_com) is then split into four separate bytes for further processing, namely:

$$ts\_hex \_com \_ 1 = ‘ 9 d ’$$

$$ts\_hex \_com \_ 2 = ‘ 65 ’$$

$$ts\_hex \_com \_ 3 = ‘ 3 f ’$$

$$ts\_hex \_com \_ 4 = ‘ f 9 ’$$

Step S140: Combining the Random Numbers with the Obfuscated Timestamp Components

In step S140, an addition operation is performed by adding each random hexadecimal number to the corresponding byte of the complemented timestamp. This process further obfuscates the timestamp and integrates randomness into the timestamp components.

### Calculation Example

$$ts\_ 1 \_hex = r1\_hex + ts\_hex \_com \_ 1 = ‘ e 04 ’ + ‘ 9 d ’ = ‘ ea 1 ’$$

$$ts\_ 2 \_hex = r2\_hex + ts\_hex \_com \_ 2 = ‘ a 62 ’ + ‘ 65 ’ = ‘ ac 7 ’$$

$$ts\_ 3 \_hex = r3\_hex + ts\_hex \_com \_ 3 = ‘ 1 c 3 ’ + ‘ 3 f ’ = ‘ 202 ’$$

$$ts\_ 4 \_hex = r4\_hex + ts\_hex \_com \_ 4 = ‘ d 09 ’ + ‘ f 9 ’ = ‘ e 02 ’$$

These results form the obfuscated-timestamp components (denoted here as ts_1_hex, ts_2_hex, ts_3_hex, and ts_4_hex), which constitute part of the au string 10.

### Step S150: Reading the ASCII Random-String Table

As shown in step S150, an ASCII random-string table is read to derive the search string 16. The ASCII random-string table is generated using a script (e.g., random_ascii.sh) and contains multiple lines (ascii_row_max) of random ASCII characters. In this example, the table consists of ten lines, as follows.

### Example ASCII Random-String Table

| | |
|---|---|
| 1. | ‘2UsXfDVurbd1ENveR74AqW8poBknOHa5JPxl3TzLFM9gyK6SIQiwYmtZG0C |
| | cjh’ |
| 2. | ‘ytdzv46KqkBfj1MsZcGVDX8YrhO9AWTL53CJgEQIUe1pxmRSoaibwnu72NH |
| | FP0’ |
| 3. | ‘VmNwBLv74UC15HkSf3Mry2czOZ0oY6DEjeKgJTWqGiIsd8hXnPbF9AxulRp |
| | Qat’ |
| 4. | ‘U21uglxzZ5bahGvCEecpjNInPMBLwkJQ78t3TWOyKd6YrDfmFRHSoXsV94A |
| | q0i’ |
| 5. | ‘gkqlX1eSByAK4rUvGLxY0IjFZWh7oniV8zuMOQfb6T5p2mNw9sRtcHEdPaCJ |
| | D3’ |
| 6. | ‘SOLG9DJrlvmE6cMwP0n2BRzNadH8AVtoUk37Y5bXig1eyhWsqKCTZp4QxFf |
| | Iju’ |
| 7. | ‘WTSw4eAmRGjXzMJdYEDhBkV3QC5IbUpHfcrnl7uxOta1sZyiKgvF9806LqP |
| | N2o’ |
| 8. | ‘aspmYN8jcDA97vtGVBwFqTL4gJdQ02KnPbXezIZhWok536uyHrUiSxlCEO1 |
| | MRf’ |
| 9. | ‘xUQ7lJKLHjab8CwWu26Vn13eYdiBTvOpI9Fy5McPXzDrgN4AfZokshtmqGR0 |
| | SE’ |
| 10. | ‘wovSsRFIzhBAWyTq5XjH20MLtr4euQm9l1gVYE8bfx7Ud6DZJcKGiaCPN3O |
| | kpn’ |

It is noteworthy that, for security considerations, the ASCII random-string table may be updated as needed by generating new data using the random_ascii.sh script. The server (e.g., SWAF NA) and client scripts (e.g., JavaScript) must update the table concurrently to maintain synchronization.

### Step S160: Determining the ASCII Data-Source Row

In step S160, the system determines which row in the ASCII random-string table will be used to generate the search string 16. This is computed using the first random hexadecimal number (r1_hex) described above.

### Calculation Example

$$Convert r 1\_ hex to decimal :$$

$$r 1\_ dec = hex \_to \_ dec ( r 1\_ hex ) = hex \_to \_ dec ( ‘ e 04 ’ ) = 3588$$

$$Determine the number of rows in the table : ascii \_row \_max = 10$$

$$Compute the row index :$$

$$ascii \_row = r 1\_ dec \% ascii \_row \_max = 3588 \% 10 = 8$$

The modulo operation ensures that the row index falls within the bounds of the table.

The Selected Row is then:

$$ascii \_data \_source = {ascii}_{-} table [ 8 ]$$

### Example ASCII Data Source (8th Row)

‘aspm YN8jcDA97vtGVBwFqTL4gJdQ02KnPbXezlZhWok536uyHrUiSxICE01MRf

### Step S170: Identifying the Positions of Predetermined Characters

As shown in step S170, the system identifies the positions of predetermined characters within the selected ASCII data source. These characters serve as constants in the search-string computation. In this embodiment, the predetermined characters are ‘H’, ‘T’, ‘D’, and ‘E’, representing the word “HIDE.”

### Calculation Example

$$s 1\_ pos \_ dec = position of ‘ H ’ in ascii \_data \_source = 49 ( 1 - based index )$$

$$s 2\_ pos \_ dec = position of ‘ I ’ in ascii \_data \_source = 38 ( 1 - based index )$$

$$s 3\_ pos \_ dec = position of ‘ D ’ in ascii \_data \_source = 10 ( 1 - based index )$$

$$s 4\_ pos \_ dec = position of ‘ E ’ in ascii \_data \_source = 57 ( 1 - based index )$$

Then convert the positions to hexadecimal:

$$s 1\_ pos \_ hex = dec \_to \_ hex ( s 1\_ pos \_ dec ) = dec \_to \_ hex ( 49 ) = ‘ 31 ’$$

$$s 2\_ pos \_ hex = dec \_to \_ hex ( s 2\_ pos \_ dec ) = dec \_to \_ hex ( 38 ) = ‘ 26 ’$$

$$s 3\_ pos \_ hex = dec \_to \_ hex ( s 3\_ pos \_ dec ) = dec \_to \_ hex ( 10 ) = ‘ 0 a ’$$

$$s 4\_ pos \_ hex = dec \_to \_ hex ( s 4\_ pos \_ dec ) = dec \_to \_ hex ( 57 ) = ‘ 39 ’$$

Step S180: Computing the search-string components

In step S180, the system performs addition operations using the positions of the predetermined characters and the corresponding random hexadecimal numbers, and uses these results to generate the search string 16.

Substeps (see also FIG. 5B):

Step S182: Identify character positions:

$$s 1\_ pos \_ dec = position of ‘ H ’ in ascii \_data \_source = 49 ( 1 - based index )$$

$$s 2\_ pos \_ dec = position of ‘ I ’ in ascii \_data \_source = 38 ( 1 - based index )$$

$$s 3\_ pos \_ dec = position of ‘ D ’ in ascii \_data \_source = 10 ( 1 - based index )$$

$$s 4\_ pos \_ dec = position of ‘ E ’ in ascii \_data \_source = 57 ( 1 - based index )$$

Step S184: Convert the positions to hexadecimal:

$$s 1\_ pos \_ hex = dec \_to \_ hex ( s 1\_ pos \_ dec ) = dec\_to \_hex ( 49 ) = ‘ 31 ’$$

$$s 2\_ pos \_ hex = dec \_to \_ hex ( s 2\_ pos \_ dec ) = dec \_to \_ hex ( 38 ) = ‘ 26 ’$$

$$s 3\_ pos \_ hex = dec \_to \_ hex ( s 3\_ pos \_ dec ) = dec \_to \_ hex ( 10 ) = ‘ 0 a ’$$

$$s 4\_ pos \_ hex = dec \_to \_ hex ( s 4\_ pos \_ dec ) = dec \_to \_ hex ( 57 ) = ‘ 39 ’$$

Step S186: Perform the addition operations:

$$s 1\_ rand \_ hex = r 1\_ hex + s 1\_ pos \_ hex = ‘ e 04 ’ + ‘ 31 ’ = ‘ e 35 ’$$

$$s 2\_ rand \_ hex = r 2\_ hex + s 2\_ pos \_ hex = ‘ a 62 ’ + ‘ 26 ’ = ‘ a 88 ’$$

$$s 3\_ rand \_ hex = r 3\_ hex + s 3\_ pos \_ hex = ‘ 1 c 3 ’ + ‘ 0 a ’ = ‘ 1 cd ’$$

$$s 4\_ rand \_ hex = r 4\_ hex + s 4\_ pos \_ hex = ‘ d 09 ’ + ‘ 39 ’ = ‘ d 42 ’$$

Step S188: Extract specific hexadecimal digits:

$$s 1\_ hex = last two digits of s 1\_ rand \_ hex = ‘ e 35 ’ \to ‘ 35 ’$$

$$s 2\_ hex = last two digits of s 2\_ rand \_ hex = ‘ a 88 ’ \to ‘ 88 ’$$

$$s 3\_ hex = last two digits of s 3\_ rand \_ hex = ‘ 1 cd ’ \to ‘ cd ’$$

$$s 4\_ hex = last two digits of s 4\_ rand \_ hex = ‘ d 42 ’ \to ‘ 42 ’$$

Step S189: Assemble the recomputed search string:

$$s \_ cal \_ rand \_ hex = s 1\_ hex ‖ s2\_hex ‖ s 3\_ hex ‖ s 4\_ hex = ‘ 35 ’ ‖ ‘ 88 ’ ‖ ‘ cd ’ ‖ ‘ 42 ’ = ‘ 3588 cd 42 ’$$

Step S190: Assembling the au string

As shown in step S190, the final au string 10 is generated by concatenating the components, including the random hexadecimal numbers (random string 14), the obfuscated-timestamp components (obfuscated timestamp 12), and the search-string components (search string 16).

Assemble the random string:

$$random\_string = r1\_hex ‖ r 2 \_ hex ‖ r3\_hex ‖ r 4\_ hex = ‘ e 04 ’ ‖ ‘ a 62 ’ ‖ ‘ 1 c 3 ’ ‖ ‘ d 09 ’ = ‘ e 04 a 621 c 3 d 09 ’$$

Assemble the obfuscated timestamp:

$$timestamp\_string = ts \_ 1 \_hex ‖ ts \_ 2 \_ hex ‖ ts \_ 3 \_hex ‖ ts \_ 4 \_ hex = ‘ ea 1 ’ ‖ ‘ ac 7 ’ ‖ ‘ 202 ’ ‖ ‘ e 02 ’ = ‘ ea 1 ac 7202 e 02 ’$$

Assemble the au string:

$$au \_string = random\_string ‖ timestamp\_string ‖ search\_string = ‘ e 04 a 621 c 3 d 09 ’ ‖ ‘ ea 1 ac 7202 e 02 ’ ‖ ‘ 3588 cd 42 ’ = ‘ e 04 a 621 c 3 d 09 ea 1 ac 7202 e 023588 cd 42 ’$$

In this embodiment, the au string is a 32-hex-character (128-bit) hexadecimal string presented entirely in lowercase, in compliance with specification requirements to ensure consistency and ease of parsing. In addition, a complement operation (with respect to 0xFFFFFFFF) is used to obfuscate the timestamp, making it difficult for an attacker to extract timing information. To enhance security, the ASCII random-string table may be rotated periodically; the server and client must update the table concurrently to remain synchronized. Although “HIDE” is used as the predetermined characters in this embodiment, the predetermined characters may be changed for security purposes without altering the core algorithm, provided the server and client reflect such changes in sync.

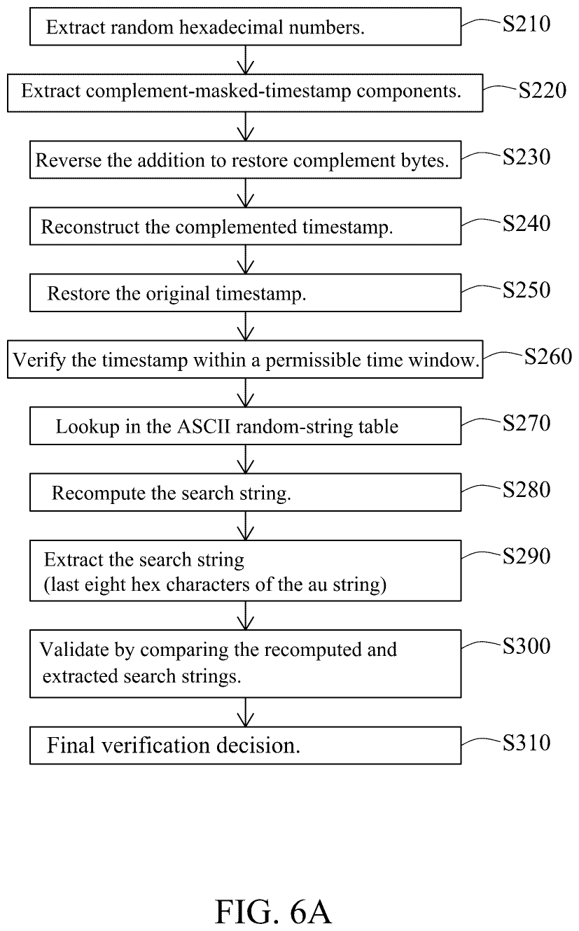

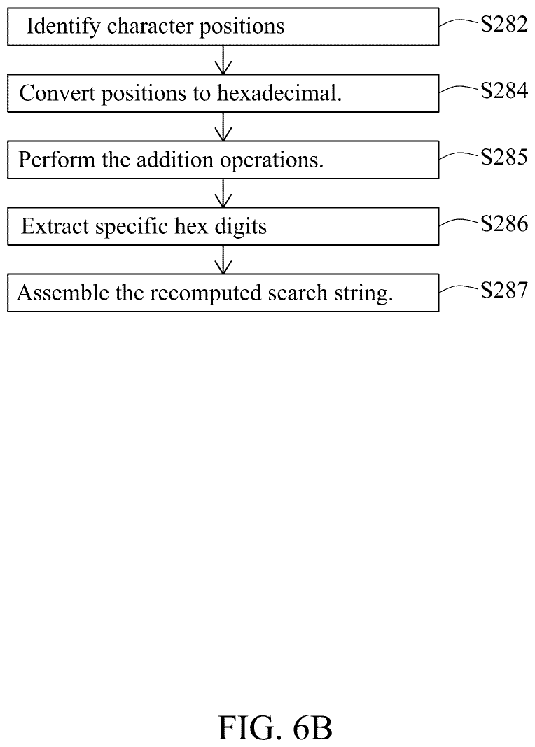

In this embodiment, the verification process is designed to carefully reconstruct and verify each component of the au string 10-namely the obfuscated timestamp 12, the random string 14, and the search string 16-which were generated during creation of the authentication string. This process ensures that the au string 10 is authentic and untampered, thereby preventing unauthorized access and replay attacks. The steps for verifying the authentication string are detailed below. Referring to FIGS. 1 and 6A, FIG. 6A illustrates a flowchart of an embodiment of the authentication algorithm verifying the authentication string.

Step S210: Extracting the random hexadecimal numbers

As shown in step S210, the verification process begins by parsing the received au string 10 to extract the random string 14, which is decomposed into four random hexadecimal numbers (r1_hex, r2_hex, r3_hex, r4_hex as shown in FIG. 6A).

Step S220: Extracting the obfuscated-timestamp components

As shown in step S220, the verification process extracts from the au string 10 the components of the obfuscated timestamp 12 (ts_1_hex, ts_2_hex, ts_3_hex, ts_4_hex as shown in FIG. 6A). These components were formed during generation by adding the random hexadecimal numbers to portions of the complemented timestamp.

Step S230: Reversing the addition to recover the complemented-timestamp components

In step S230, the system performs reverse addition to recover the complemented-timestamp components (ts_hex_com_1, ts_hex_com_2, ts_hex_com_3, ts_hex_com_4 as shown in FIG. 6A). This is accomplished by subtracting the corresponding random hexadecimal numbers from the obfuscated-timestamp components.

### Calculation Example

$$ts \_ hex \_com \_ 1 = ts \_ 1 \_ hex - r 1 \_ hex = ‘ ea 1 ’ - ‘ e 04 ’ = ‘ 9 d ’$$

$$ts \_ hex \_com \_ 2 = ts \_ 2 \_ hex - r 2 \_ hex = ‘ ac 7 ’ - ‘ a 62 ’ = ‘ 65 ’$$

$$ts \_ hex \_com \_ 3 = ts \_ 3 \_ hex - r3\_ hex = ‘ 202 ’ - ‘ 1 c 3 ’ = ‘ 3 f ’$$

$$ts \_ hex \_com \_ 4 = ts \_ 4 \_ hex - r4\_ hex = ‘ e 02 ’ - ‘ d 09 ’ = ‘ f 9 ’$$

These calculations reconstruct the individual bytes of the complemented timestamp (ts_hex_com as shown in FIG. 6A), which will be used to restore the original timestamp.

Step S240: Reconstructing the complemented timestamp

As shown in step S240, the complemented-timestamp components are concatenated to form the complete complemented timestamp (ts_hex_com as shown in FIG. 6A).

### Concatenation Example

$$ts \_ hex \_ com = ts \_ hex \_ com \_ 1 ‖ ts \_ hex \_ com \_ 2 ‖ ts \_ hex \_ com \_ 3 ‖ ts \_ hex \_ com \_ 4 = ‘ 9 d ’ ‖ ‘ 65 ’ ‖ ‘ 3 f ’ ‖ ‘ f 9 ’ = ‘ 9 d 653 ff 9 ’$$

Step S250: Restoring the original timestamp

In step S250, the original timestamp (ts_hex as shown in FIG. 6A) is restored by removing the complement obfuscation—i.e., by taking the complement of the complemented timestamp.

### Calculation Example

$$ts \_ hex = 0 xFFFFFFFF - ts \_ hex \_ com = 0 xFFFFFFFF - ‘ 9 d 653 ff 9 ’ = ‘ 629 ac 006 ’$$

The hexadecimal timestamp is then converted back to its decimal form (ts_dec as shown in FIG. 6A) to represent the actual time.

### Conversion Example

$$ts \_ dec = hex\_to \_dec ( ‘ 629 ac 006 ’ ) = 1654308870$$

Step S260: Timestamp verification

As shown in step S260, the timestamp is verified to ensure that it falls within a permissible time window, thereby preventing replay attacks using expired au strings 10. The current time (now( ) as shown in FIG. 6A) is obtained, and the difference between now ( ) and ts_dec is computed.

### Verification Example

The permissible time difference (ts_diff_allow as shown in FIG. 6A) is set to 7,200 seconds (i.e., 2 hours).

$$ts \_ flag = ( now ( ) - ts \_ dec ) \leq ts \_diff \_allow ? “ true ” : “ false ”$$

If ts_flag is “true,” the timestamp is considered valid; otherwise, the au string 10 is rejected due to an expired timestamp.

### Step S270: ASCII Random-String Table Lookup

In step S270, the ASCII data source used during generation is recomputed. Using the extracted value r1_hex, the specific row in the ASCII random-string table is determined.

### Calculation Example

$$r 1\_ dec = hex \_to \_ dec ( r 1\_ hex ) = hex \_to \_ dec ( ‘ e 04 ’ ) = 3588$$

$$ascii\_row \_max = total number of rows in the ASCII table ( e . g . , 10 )$$

$$ascii\_row = r 1\_ dec \% ascii\_row \_max = 3588 \% 10 = 8$$

The ASCII data source is then retrieved from the table:

$$ascii\_data \_source = ascii\_table [ ascii\_row ] = ascii\_table [ 8 ]$$

In this example, the ASCII data source is the 8th row of the ASCII table:

‘aspm YN8jcDA97vtGVBwFqTL4gJdQ02KnPbXezIZhWok536uyHrUiSxlCEO1MR f’

### Step S280: Recomputing the Search String

As shown in step S280, the search string 16 is reconstructed by identifying the positions of predetermined characters within the selected ASCII data source (the characters ‘H’, ‘T’, ‘D’, and ‘E’, as shown in FIG. 6B) and adding them to the corresponding random hexadecimal numbers.

### Substeps (See Also FIG. 6B):

S282: Identify character positions:

$$s 1\_ pos \_ dec = position of ‘ H ’ in ascii\_data \_source = 49 ( 1 - based index )$$

$$s 2\_ pos \_ dec = position of ‘ I ’ in ascii\_data \_source = 38 ( 1 - based index )$$

$$s 3\_ pos \_ dec = position of ‘ D ’ in ascii\_data \_source = 10 ( 1 - based index )$$

$$s 4\_ pos \_ dec = position of ‘ E ’ in ascii\_data \_source = 57 ( 1 - based index )$$

S284: Convert the positions to hexadecimal:

$$s 1\_ pos \_ hex = dec \_ to \_ hex ( s1\_pos \_dec ) = dec \_ to \_ hex ( 49 ) = ‘ 31 ’$$

$$s 2\_ pos \_ hex = dec \_ to \_ hex ( s2\_pos \_dec ) = dec \_ to \_ hex ( 38 ) = ‘ 26 ’$$

$$s 3\_ pos \_ hex = dec \_ to \_ hex ( s3\_pos \_dec ) = dec \_ to \_ hex ( 10 ) = ‘ 0 a ’$$

$$s 4\_ pos \_ hex = dec \_ to \_ hex ( s4\_pos \_dec ) = dec \_ to \_ hex ( 57 ) = ‘ 39 ’$$

S285: Perform the addition operations:

$$s 1\_ rand \_ hex = r 1\_ hex + s1\_pos \_hex = ‘ e 04 ’ + ‘ 31 ’ = ‘ e 35 ’$$

$$s 2\_ rand \_ hex = r 2\_ hex + s2\_pos \_hex = ‘ a 62 ’ + ‘ 26 ’ = ‘ a 88 ’$$

$$s 3\_ rand \_ hex = r 3\_ hex + s3\_pos \_hex = ‘ 1 c 3 ’ + ‘ 0 a ’ = ‘ 1 cd ’$$

$$s 4\_ rand \_ hex = r 4\_ hex + s4\_pos \_hex = ‘ d 09 ’ + ‘ 39 ’ = ‘ d 42 ’$$

S286: Extract specific hexadecimal digits:

$$s 1\_ hex = last two digits of s1\_r and \_hex = ‘ e 35 ’ \to ‘ 35 ’$$

$$s 2\_ hex = last two digits of s2\_r and \_hex = ‘ a 88 ’ \to ‘ 88 ’$$

$$s 3\_ hex = last two digits of s3\_r and \_hex = ‘ 1 cd ’ \to ‘ cd ’$$

$$s 4\_ hex = last two digits of s4\_r and \_hex = ‘ d 42 ’ \to ‘ 42 ’$$

S287: Assemble the recomputed search string:

$$s \_ cal \_ rand \_ hex = s1 \_ hex ‖ s2 \_ hex ‖ s3 \_ hex ‖ s4 \_ hex = ‘ 35 ’ ‖ ‘ 88 ’ ‖ ‘ cd ’ ‖ ‘ 42 ’ = ‘ 3588 cd 42 ’$$

Step S290: Extracting the search string from the au string

In step S290, the system extracts the search string from the received au string 10.

### Extraction Example

$$s \_ au \_ rand \_ hex = the last eight hex characters of the au string ( i . e . , characters 25 through 32 , 8 hex characters ) = ‘ 3588 cd 42 ’$$

Step S300: Verifying the search string

As shown in step S300, the recomputed search string (s_cal_rand_hex) is compared with the search string extracted from the au string (s_au_rand_hex).

### Comparison Example

$$compare\_flag = ( s \_ cal \_ rand \_ hex == s \_ au \_ rand \_ hex ) ? “ true ” : “ false ”$$

If compare_flag is “true,” the search string is regarded as valid.

### Step S310: Final Verification Decision

In step S310, the system makes a final verification decision based on the timestamp-verification result (ts_flag) and the search-string verification result (compare_flag).

### Decision Example

$$allow\_flag = ( t s \_ flag == “ true ” \&\& compare\_flag == “ true ” ) ? “ true ” : “ false ”$$

If allow_flag is “true,” verification succeeds and the network request is allowed to proceed; if “false,” verification fails and the request is rejected or additional security measures are initiated.

The verification process above carefully reconstructs each component of the au string 10 to ensure authenticity. In summary, in this verification process, the random hexadecimal numbers are extracted directly from the au string. The obfuscated timestamp is then reconstructed by reversing the addition and removing the complement masking, after which it is verified to fall within the permissible time window to prevent replay attacks. Next, the search string 16 is recomputed using the same algorithm as in the generation process to ensure that the au string 10 has not been tampered with. The final decision is based on successful verification of both the timestamp and the search string.

By verifying the timestamp within an allowable time window, the reuse of old au strings is prevented, thereby strengthening resistance to replay attacks. Moreover, the use of random hexadecimal numbers together with a dynamic ASCII random-string table makes it extremely difficult for attackers to predict or reproduce a valid au string. Detailed comparison of the recomputed values with the extracted components further ensures the integrity of the au string.

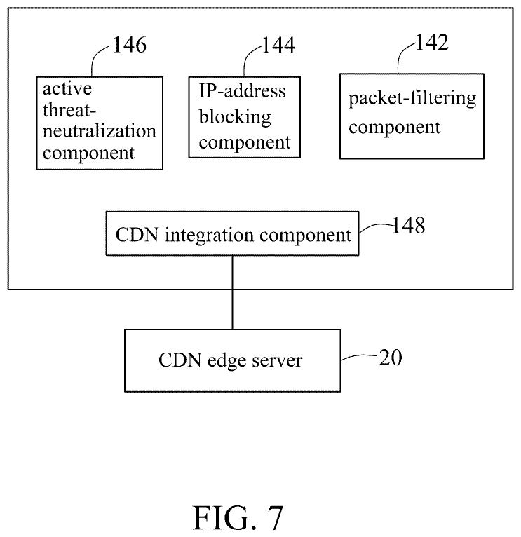

Referring to FIGS. 1 and 7, FIG. 7 illustrates an architectural diagram of an embodiment of the defense response module of the present invention. When a threat is detected or verification fails, the defense response module 140 is activated to implement a multilayer defense strategy. The defense response module 140 includes a packet-filtering component 142, an IP-address blocking component 144, an active threat-neutralization component 146, and a Content Delivery Network (CDN) integration component 148 (hereinafter, the “CDN integration component 148”).

The packet-filtering component 142 involves deep packet inspection (DPI), which analyzes malicious content in packet headers and payloads; protocol anomaly detection to identify deviations from standard protocol behavior; and signature-based filtering to block packets that match known malicious signatures. The IP-address blocking component 144 is realized through a dynamic blocklist, which automatically adds suspicious IP addresses based on threat intelligence and AI analysis. The IP-address blocking component 144 also provides geo-IP blocking to restrict access from specific geographic locations when necessary.

The active threat-neutralization component 146 is executed by custom scripts written in languages such as Python, Bash, or C/C++. These scripts respond to threats by terminating malicious processes, isolating infected devices, or performing other predetermined security actions. Automated response workflows orchestrate complex response actions without human intervention, thereby achieving rapid and effective threat mitigation.

The CDN integration component 148 plays a key role in mitigating large-scale DDoS attacks by distributing network load across the CDN. Cooperation with CDN edge servers 20 enables the network security system 100 to filter malicious traffic before it reaches the origin servers, leveraging the CDN's high-bandwidth capacity to absorb excessive traffic and to maintain service availability during large-scale attacks. The network security system 100 is designed to be highly scalable and compatible with existing network infrastructure. It operates within a virtual-machine architecture compatible with mainstream Linux environments and hyper-converged infrastructure (HCl), allowing dynamic resource allocation according to network load to ensure optimal performance. The network security system 100 supports an active-active operational mode, in which multiple virtual machines run concurrently to provide load balancing and fault tolerance, thereby improving reliability and performance. This configuration ensures high availability, prevents single points of failure, and allows the system to continue operating during maintenance or unexpected downtime.

Integration with existing systems is facilitated through standard interfaces such as APIs and standard protocols, enabling tight communication with Web Application Firewalls (WAFs) and other security systems. Custom interfaces are also supported to provide tailored integration with proprietary systems as needed. The modular design of the network security system 100 ensures that each component can be updated or replaced without affecting the entire system, providing flexibility and ease of customization according to specific security requirements. The modular architecture of the network security system 100 allows organizations to deploy specific modules based on their security needs, enhancing the system's adaptability to diverse environments and use cases.

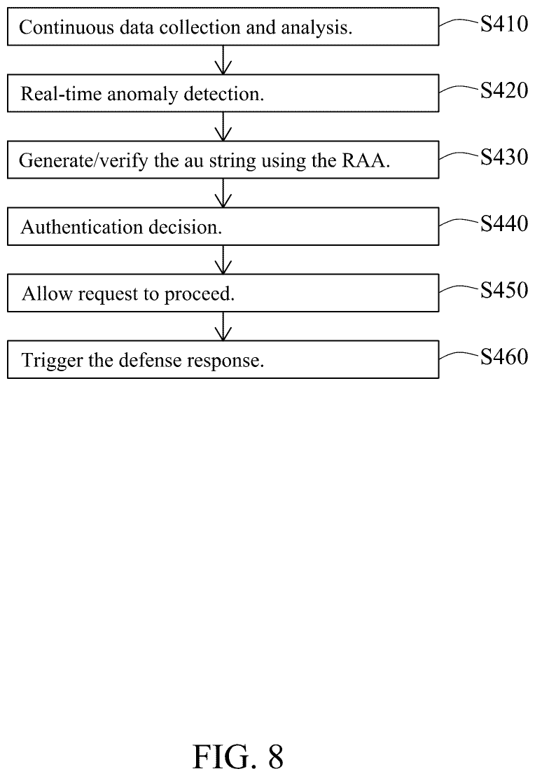

In summary, an overall operational flow of the network security system 100 is described below. Referring to FIG. 8, FIG. 8 illustrates an operational flow of an embodiment of the network security system. First, as shown in step S410, the operational flow of the network security system 100 begins with continuous data collection and analysis, in which the data collection module 110 gathers comprehensive network data. Then, as shown in step S420, the AI analysis engine 120 processes the data in real time to detect anomalies. Upon receipt of a network request, as shown in step S430, the authentication module 130 uses the Reverse Authentication Algorithm to generate or verify an au string. Next, step S440 is executed: if verification succeeds, the request is allowed to proceed (step S450); if verification fails, the defense response module 140 is triggered (step S460).

In summary, the network security system is designed to be flexible and adaptable, permitting various modifications and enhancements. The Reverse Authentication Algorithm (RAA) may be modified to incorporate different cryptographic techniques or to adjust the length of the au string to meet specific security requirements. The system can also be integrated with Security Information and Event Management (SIEM) systems to enable centralized monitoring and management of security events. In addition, the network security system can be deployed in cloud environments such as AWS, Azure, or Google Cloud Platform, broadening its applicability and ensuring that it satisfies the diverse needs of modern enterprises. This detailed description outlines a sophisticated network security system that combines AI-driven behavioral analytics with a novel RAA to provide robust protection against a wide range of network threats. Through real-time detection and response, dynamic authentication, and tight integration with existing infrastructure, the invention addresses critical gaps in traditional approaches to network security. Its modular design, scalability, and adaptability make it a valuable asset for organizations seeking to strengthen their security posture in an increasingly complex threat landscape.

While specific embodiments have been described for purposes of illustration, those of ordinary skill in the art will recognize that various modifications, substitutions, and changes may be made without departing from the spirit and scope of the present disclosure. Accordingly, the scope of the claimed subject matter is defined solely by the appended claims and their equivalents.

What is claimed is:

1. A network security system for detecting and responding to threats in a network environment, the network security system comprising:
a data collection module configured to collect network data including a timestamp;
hexadecimal (base-16) and applying a bitwise one's-complement with respect to 0xFFFFFFFF to mask the original value, and combining the complement-masked timestamp with the random string; and
a defense response module configured to initiate layered defense responses upon detection of the anomalous pattern or upon authentication failure.

2. The network security system of claim 1, wherein the Reverse Authentication Algorithm periodically updates the ASCII random string table to enhance security and prevent predictability.

3. The network security system of claim 1, wherein the authentication module verifies an incoming network request by decomposing a received authentication string to extract and verify the complement-masked timestamp, the random string, and the search string, the verification comprising: reversing the complement operation applied to the complement-masked timestamp to restore an original timestamp and verifying that the restored timestamp is within a permissible time window to prevent replay attacks; and recomputing the search string and comparing the recomputed search string with a search string extracted from the authentication string to ensure integrity.

4. The network security system of claim 1, wherein the defense response module comprises:
a packet-filtering component configured to remove malicious data; an IP-address blocking component configured to block suspicious IP addresses by adding their sources to a blocklist;
an active threat-neutralization component configured to execute at least one custom script to proactively neutralize identified threats; and a content-delivery-network (CDN) integration component configured to distribute network traffic so as to mitigate volumetric distributed-denial-of-service attacks.

5. The network security system of claim 1, wherein the AI analysis engine further comprises an AI auditor component configured to perform in-depth analysis of user-behavior patterns to detect insider threats.

6. A network security method automatically performed by a network security system, the method comprising:
collecting, by a data collection module, network data including a timestamp;
analyzing, by an AI analysis engine, the collected data using AI-based behavioral analysis to identify anomalous patterns indicative of network-security threats;
generating, by an authentication module using a Reverse Authentication Algorithm, a unique authentication string comprising:
a random string composed of random hexadecimal numbers generated within a specified range;
a complement-masked timestamp obtained by acquiring a current timestamp, converting the timestamp to hexadecimal, applying a complement operation, and combining the complement-masked timestamp with the random hexadecimal numbers; and
a search string produced by: selecting, based on a modulo operation on one of the random hexadecimal numbers, an ASCII data-source row from an ASCII random string table;
identifying a position of a predetermined character in the selected row; and
adding the one random hexadecimal number and the position and extracting specific hexadecimal digits to form the search string;
verifying an incoming network request by decomposing a received authentication string to extract and verify the complement-masked timestamp, the random hexadecimal numbers, and the search string, including:
reversing the masking to restore an original timestamp and verifying that the restored timestamp is within a permissible time window to prevent replay attacks; and
recomputing the search string and comparing the recomputed search string with a search string extracted from the authentication string to ensure integrity; and
initiating, by a defense response module, a layered defense response upon detecting the anomalous pattern or an authentication failure.
